(19) United States
(12) Patent Application Publication
(10) Pub. No.: US 2012/0105189 A1
(43) Pub. Date: May 3, 2012

(54) IGNITION COIL FOR SPARK PLUGS

(76) Inventor: Hong-Jen TSAI, Rende Township (TW)

(21) Appl. No.: 12/917,235

(22) Filed: Nov. 1, 2010

(51) Int. Cl. H01F 17/04

(52) U.S. Cl. 336/221

(57) ABSTRACT

An ignition coil includes a body and a magnetic conductive socket is located in the space of the body. An iron core is located in the magnetic conductive socket and has a first end with which a permanent magnet is in contact. An initial coil and a sub-coil are located between the magnetic conductive socket and the iron core. A magnetic conductive member is located in the space of the body and located close to the permanent magnet. The magnetic conductive member is located close to the magnetic conductive socket so that the magnetic lines of the magnetic conductive member are extended to increase the magnetic flux to make the sub-coil to induct higher voltage.

### FIELD OF THE INVENTION

The present invention relates to an ignition coil, and more particularly, to an ignition coil for spark plugs to prolong the ignition period to obtain better ignition to the engine.

### BACKGROUND OF THE INVENTION

A conventional ignition coil is used to generate high voltage so as to create sparks for the spark plug and the sparks in the engine will ignite the fuel to generate force. The differences of the engines such as the ratio of the fuel and air may vary the efficiency of the ignition. If the sparks cannot ignite the fuel, the engine cannot work to provide power to the vehicle. The value of the voltage depends upon the structure and the material of the ignition coil, the higher value of the voltage the ignition coil generates, the easier the engine starts.

The existed ignition coils are focused on the improvement of the iron core. One of the improved ignition coils includes a hollow tube with circular cross section and a core is inserted into the hollow tube. The core is composed of multiple iron plates with different widths and the iron plates form a substantially circular cross section. The core is divided into multiple sections along the vertically overlapped direction so as to increase the space coefficient and to ensure the core can be easily inserted into the hollow tube and the loss of the vortex current can be minimized. By this arrangement, the secondary voltage can be generated and output.

Another improved ignition coil includes a case, an iron core, an initial coil unit and a sub-coil unit, wherein the iron core is located in the case and is made of soft magnetic compound material which is pressed in a transverse direction to form the integral cylindrical iron core. The initial coil unit and the sub-coil unit are located between the case and the iron core. The soft magnetic compound material of the iron core has even density and can increase the value of the voltage.

In order to improve the shortcomings of the conventional ignition coil of spark plugs, the present invention intends to provide an ignition coil which prolongs the ignition period for the spark plugs.

### SUMMARY OF THE INVENTION

The present invention relates to an ignition coil which comprises a body having a space defined therein and a magnetic conductive socket is located in the space of the body. An iron core is located in the magnetic conductive socket and has a first end. An initial coil and a sub-coil are located between the magnetic conductive socket and the iron core. A permanent magnet is located in the space of the body and contacts the first end of the iron core. A magnetic conductive member is located in the space of the body and located close to the permanent magnet. The magnetic conductive member is located close to the magnetic conductive socket.

The magnetic conductive member is in contact with the permanent magnet.

The magnetic conductive member includes a flange extending toward the magnetic conductive socket and the flange is located close to the magnetic conductive socket.

The iron core has a second end which is located in opposite to the first end and another permanent magnet is connected to the second end of the iron core.

The magnetic conductive member is made of one of the following materials which are iron plates, silicon-steel plates, permalloy, high magnetic superconductive alloy or supermalloy.

The magnetic conductive member is 1.3 mm in thickness, 26 mm in length and 24 mm in width.

The sub-coil is wrapped to the iron core and the initial coil is wrapped to the sub-coil.

The magnetic conductive member increases the magnetic flux to let the sub-coil to generate higher voltage which prolongs the ignition period of the ignition coil to improve the ignition efficiency.

The magnetic conductive member increases the ignition period 28.9% than the conventional ignition period so as to have better ignition efficiency.

The manufacturing cost of the ignition coil is close to that of the conventional ignition coil, but the difference of the efficiency is significant.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of the ignition coil of the present invention;

FIG. 2 shows the magnetic lines of the ignition coil of the present invention cooperated with the magnetic conductive member, and

FIG. 3 is a cross sectional view of another embodiment of the ignition coil of the present invention.

### DETAILED DESCRIPTION OF THE PREFERRED EMBODIMENT

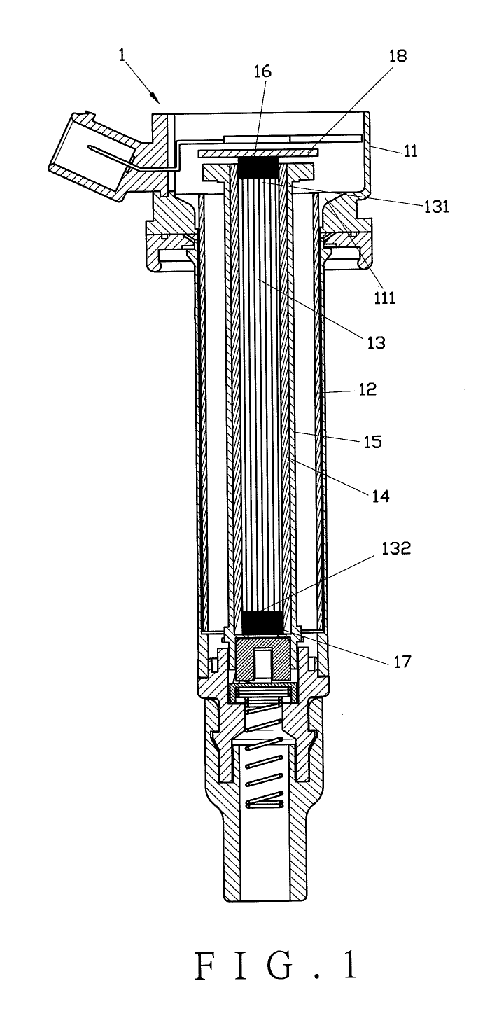

Referring to FIG. 1, the ignition coil 1 of the present invention comprises a body 11 having a space 111 defined therein. The ignition coil 1 is cooperated with a spark plug to generate sparks to start engines. A magnetic conductive socket 12 is located in the space 111 of the body 11. An iron core 13 is located in the magnetic conductive socket 12 and has a first end 131 and a second end 132 which is located in opposite to the first end 131. The iron core 13 is a cylindrical core.

An initial coil 15 and a sub-coil 14 are located between the magnetic conductive socket 12 and the iron core 13, wherein the sub-coil 14 is wrapped to the iron core 13 and the initial coil 15 is wrapped to the sub-coil 14.

A permanent magnet 16 is located in the space 111 of the body 1 and contacts the first end 131 of the iron core 13. The permanent magnet 16 is 1.0 mm in thickness, 6.5 mm in length and width. Another permanent magnet 17 is connected to the second end 132 of the iron core 13 to have better ignition efficiency.

A magnetic conductive member 18 is located in the space 111 of the body 1 and located close to the permanent magnet 16. The magnetic conductive member 18 is further located close to the magnetic conductive socket 12. The magnetic conductive member 18 is 1.3 mm in thickness, 26 mm in length and 24 mm in width. The magnetic conductive member 18 is made of one of the following materials which are iron plates, silicon-steel plates, permalloy, high magnetic superconductive alloy or supermalloy. The preferable embodiment of the magnetic conductive member 18 is made of iron and preferably, the magnetic conductive member 18 attached to the permanent magnet 16.

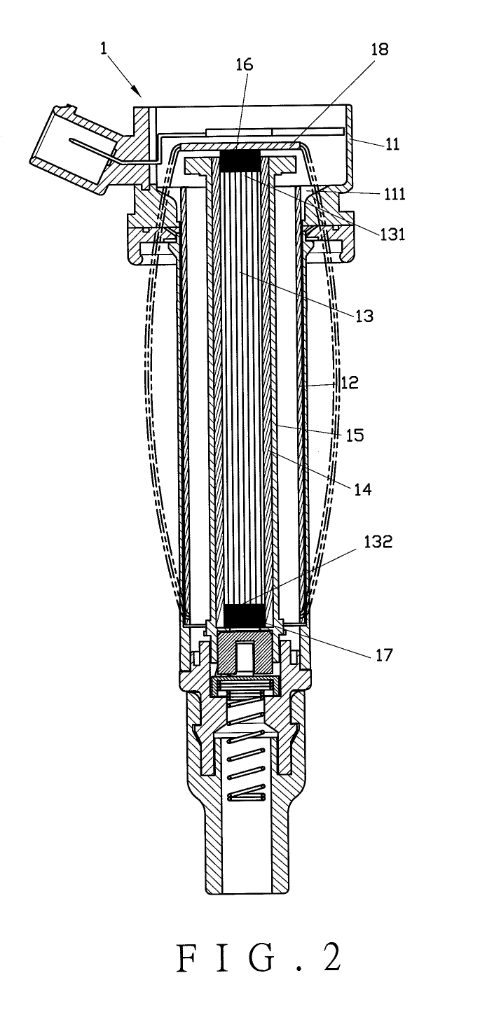

As shown in FIG. 2, when the ignition coil 1 is activated, the battery (not shown) provides the initial coil 15 with low voltage to allow the iron core 13 and the two permanent magnets 16, 17 to generate a magnetic field, and the low voltage is suddenly cut off to let the sub-coil 14 to generate high voltage. These steps are well known in the art and need not to be described in detail. During the action of the magnetic conductive member 18, the magnetic field of the permanent magnet 16 is extended so that the magnetic conductive socket 12 is conducted the extended magnetic field, so that the magnetic lines are extended by the magnetic conductive socket 12 to generate more magnetic flux during the ignition process and higher voltage such that the time for generating the sparks of the spark plug can be prolonged.

Accordingly, when comparing two spark plugs with the same coefficient, the time that the sparks last for the ignition coil 1 cooperated with the magnetic conductive member 18 is 116/1000 seconds. The time that the sparks last for the ignition coil not cooperated with the magnetic conductive member 18 is 90/1000 seconds. The ignition coil 1 with the magnetic conductive member 18 increases the ignition period 28.9% than the conventional ignition period.

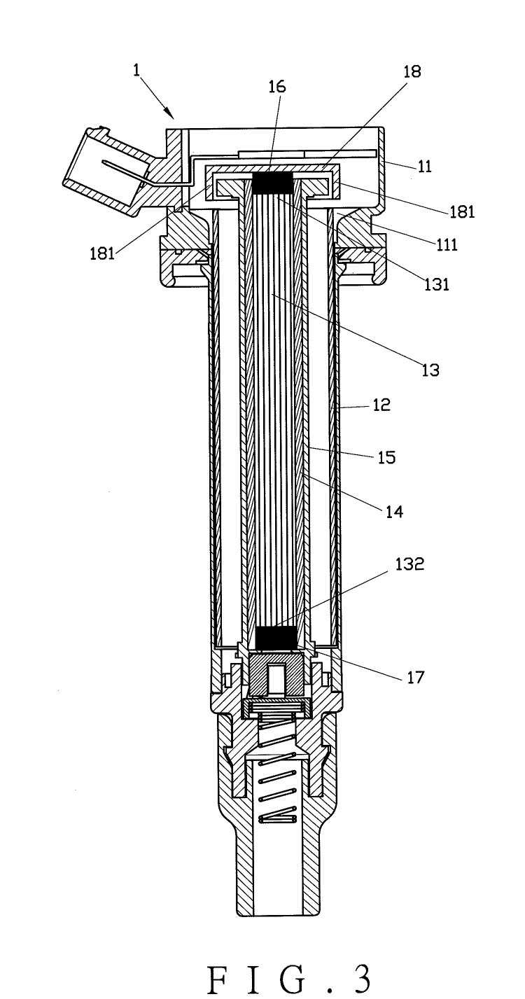

As shown in FIG. 3, in order to allow the magnetic conductive member 18 to be more close to the magnetic conductive socket 12, the magnetic conductive member 18 includes a flange 181 extending toward the magnetic conductive socket 12, and the flange 181 is located close to the magnetic conductive socket 12 so as to guide the magnetic lines to the magnetic conductive socket 12.

It is noted that the form of the magnetic conductive member 18 is not limited to the disclosed form and other suitable form of the magnetic conductive member is included in the invention.

While we have shown and described the embodiment in accordance with the present invention, it should be clear to those skilled in the art that further embodiments may be made without departing from the scope of the present invention.

What is claimed is:

1. An ignition coil comprising:
a body having a space defined therein;
a magnetic conductive socket located in the space of the body;
an iron core located in the magnetic conductive socket and having a first end;
an initial coil located between the magnetic conductive socket and the iron core;
a sub-coil located between the magnetic conductive socket and the iron core;
a permanent magnet located in the space of the body and contacting the first end of the iron core, and
a magnetic conductive member located in the space of the body and located close to the permanent magnet, the magnetic conductive member located close to the magnetic conductive socket.

2. The coil as claimed in claim 1, wherein the magnetic conductive member is in contact with the permanent magnet.

3. The coil as claimed in claim 1, wherein the magnetic conductive member includes a flange extending toward the magnetic conductive socket, and the flange is located close to the magnetic conductive socket.

4. The coil as claimed in claim 1, wherein the iron core has a second end which is located in opposite to the first end and another permanent magnet is connected to the second end of the iron core.

5. The coil as claimed in claim 1, wherein the magnetic conductive member is made of one of the following materials which are iron plates, silicon-steel plates, permalloy, high magnetic superconductive alloy or supermalloy.

6. The coil as claimed in claim 1, wherein the magnetic conductive member is 1.3 mm in thickness, 26 mm in length and 24 mm in width.

7. The coil as claimed in claim 1, wherein the sub-coil is wrapped to the iron core and the initial coil is wrapped to the sub-coil.
